(19) United States
(12) Patent Application Publication
(10) Pub. No.: US 2013/0177273 A1
(43) Pub. Date: Jul. 11, 2013

(54) Cylindrical Vector Beam Generation From A Multicore Optical Fiber

(71) Applicants: Robert R. Alfano, Bronx, NY (US); Michael Etienne, Corning, NY (US); Giovanni Milione, New York, NY (US); Daniel Aloysius Nolan, Corning, NY (US); Henry Sztul, New York, NY (US); Ji Wang, Painted Post, NY (US)

(72) Inventors: Robert R. Alfano, Bronx, NY (US); Michael Etienne, Corning, NY (US); Giovanni Milione, New York, NY (US); Daniel Aloysius Nolan, Corning, NY (US); Henry Sztul, New York, NY (US); Ji Wang, Painted Post, NY (US)

(73) Assignees: Research Foundation of CUNY on behalf of City College, New York City, NY (US); Corning Incorporated, Corning, NY (US)

(21) Appl. No.: 13/809,618

(22) PCT Filed: Jul. 12, 2011
(86) PCT No.: PCT/US2011/043625

§ 371 Date: Mar. 27, 2013

Related U.S. Application Data
(60) Provisional application No. 61/363,459, filed on Jul. 12, 2010.

(51) Int. Cl. G02B 6/10; G02B 6/024

(52) U.S. Cl. CPC G02B 6/105; G02B 6/024
USPC 385/11; 385/126; 385/115

(57) ABSTRACT

A multicore optical component and corresponding methods of converting a linearly or circularly polarized Gaussian beam of light into a radially or azimuthally polarized beam of light are provided. The multicore optical component comprises a plurality of birefringent, polarization maintaining elliptical cores. The elliptical cores collectively define an azimuthally varying distribution of major axes where the orientation of the major axis of a given elliptical core is given by φ=(180/N)*n+θ where n is the core number and θ is any angle greater than 0°.

### CROSS REFERENCE TO RELATED APPLICATIONS

This application claims the benefit of priority under 35 U.S.C. §119 of U.S. Provisional Application Ser. No. 61/363,459, filed Jul. 12, 2010, the content of which is relied upon and incorporated herein by reference.

### BACKGROUND

Cylindrically polarized light, more particularly radially and azimuthally polarized light, are desirable for a number of important applications. These applications include, but are not limited to, lithography, electron acceleration, material processing, and metrology. There are currently no simple methods or devices for converting a linearly polarized Gaussian beam of light into a radially or azimuthally polarized beam of light.

For example, it is possible to use multi-mode fibers in conjunction with a number of micro optic components such as asymmetric phase plates, half wave plates, and polarization controllers to convert an input Gaussian beam to a cylindrically polarized beam. In these approaches, one typically needs to first convert the input Gaussian beam to an asymmetric beam using a phase plate and then use a number of polarization components to enable conversion to a cylindrical polarization mode. This approach can be efficient but the required number of relatively expensive components typically necessitates an expensive and cumbersome device.

### SUMMARY

A method for the generation of cylindrical vector beams based on the design of a multicore optical fiber is presented. The principle of operation is based on the property of birefringence in polarization maintaining elliptical cores. This design consists of N elliptical cores symmetrically arranged in a circular array about the fiber axis, where the orientation of each core's major axes has an azimuthally varying distribution, i.e., the angular orientation of each core's major axis varies as a function of the angular position of the core in the circular array. The guided mode of each core rotates an incident polarization according to the core's orientation in the array, and the array's overall birefringence can be described using a Jones matrix analysis. Coherent superposition of the azimuthally distributed polarization outputs from each individual core in the far field produces a cylindrically symmetric amplitude and polarization state. In this way, a Gaussian beam coupled at the fiber input can be transformed into a cylindrical vector beam. This method does not rely on the direct excitation of the higher order TM, TE, and HE fiber modes. Stokes polarimetry measurements of the fiber output in the near and far field can be used for experimental investigation of the fabrication of multicore fiber designs according to the present disclosure with, for example, N=6 cores of varying core size and spacing. These measurements can be used to investigate the efficiency of the design and to generate numerical simulations of the far field output for scaling to more than N=6 cores and for varying core spacing.

Hence, the present disclosure introduces a multicore optical component capable of converting linearly or circularly polarized input radiation to cylindrically polarized radiation, including both radial and azimuthal polarization. Multicore optical components according to the present disclosure can be fabricated as unitary redrawn optical components.

### BRIEF DESCRIPTION OF THE DRAWINGS

FIGS. 1A-1C illustrate the use of a multicore optical component to convert linearly polarized input radiation to radially polarized output radiation.

FIGS. 2A-2C illustrate the use of a multicore optical component to convert linearly polarized input radiation to azimuthally polarized output radiation.

### DETAILED DESCRIPTION OF THE PREFERRED EMBODIMENTS

We propose the use of an array of polarizing single mode elliptical cores for the purpose of converting an arbitrary incoming polarization, i.e. linear or circularly polarized light, to cylindrical vector beams that have azimuthally varying polarization. The cores are properly aligned and the component is cut to an appropriate length that allows the polarization in each core to rotate to the desired orientation.

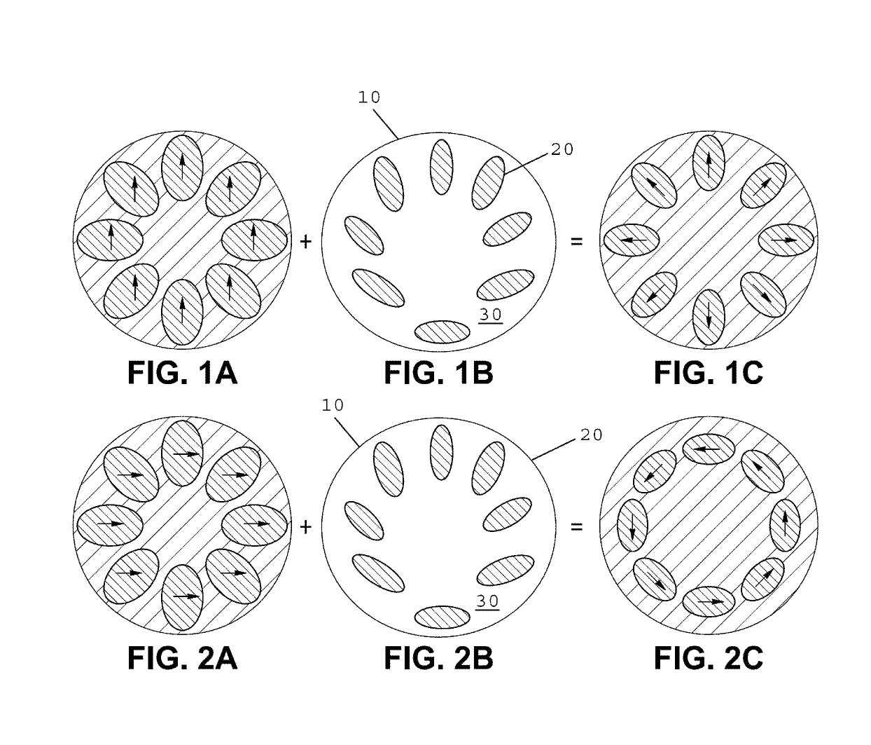

Generally, FIGS. 1A-1C illustrate the use of a multicore optical component 10 to convert linearly polarized input radiation (see FIG. 1A) to radially polarized output radiation (see FIG. 1C), while FIGS. 2A-2C illustrate the use of a multicore optical component 10 to convert linearly polarized input radiation (see FIG. 2A) to azimuthally polarized output radiation (see FIG. 2C). When linearly polarized light is input into the component 10, each of the multiple elliptical cores 20 guides a portion of the light to the output of the component 10. Light not guided by the elliptical cores 10 can be extracted by a high index ring or high index coating on the outside circumference of the component.

Each elliptical core 20 rotates the polarization as would a half waveplate. The orientation of each elliptical core is chosen so that the polarization of the input light, being linearly polarized as in FIGS. 1A and 2A, will be rotated such that light output from the component will be highly radially or azimuthally polarized, depending on the orientation of the input light.

FIGS. 1B and 2B illustrate the geometry of a multicore optical component 10 according to the present disclosure, in cross section. The component 10 comprises a plurality of birefringent, polarization maintaining elliptical cores 20 surrounded by cladding material 30. The elliptical cores 20 are configured for optical propagation and extend from a common input end of the optical component to a common output end of the optical component. More specifically, the multicore optical component 10 comprises N elliptical cores 20 symmetrically arranged in a circular array. The elliptical cores 20 collectively define an azimuthally varying distribution of major axes. The orientation co of the major axis of a given elliptical core is given by

φ=(180/N)*n+θ

where n is the core number and θ is an offset angle including 0°.

The multicore optical component may be an optical fiber bundle drawn, for example, from a fiber perform comprising a plurality of core canes. For example, in one contemplated embodiment, the multicore optical component comprises a six-core device fabricated using six core canes contained within a fiber perform tube. Core canes of this nature may, for example, be characterized by a 2 to 1 ratio of cladding diameter to core diameter. The core of the core cane may, for example, be characterized by a major axis that is between approximately two and approximately three times larger than the minor axis. It is contemplated that smaller diameter filler canes without a core can be incorporated into the tube to fill the tube with glass.

The multicore optical component of the present disclosure may be designed such that the modal volume can be increased to an arbitrarily large number. Indeed, it is contemplated that the number of cores is not limited to six, eight or even one annular row. In any case, the orientation of the major polarization axis of each core is such that a complete revolution of all the axes occurs around the circumference of the component. In addition, although the optical component of the present disclosure is referred to herein as a multicore optical fiber, it is contemplated that the component may be presented in a variety of forms, e.g., as a composite of multiple guided wave cores.

In the embodiment illustrated in FIG. 1B, the respective major axes of the elliptical cores are oriented such that each core is rotated by 22.5° with an initial orientation of 0°, i.e. 0°, 22.5°, 45°, 67.5°, 90°, 112.5°, 135°, and 157.5° . In general, where the number of cores is N, the orientation of the major axis is given by:

φ=(180/N)*n,

where φ is the orientation of the major axis of the elliptical core and n is the core number, i.e. 1, 2, 3, 4, . . .

It is contemplated that the respective major axes of the elliptical cores can be offset from those illustrated in FIG. 1B by any given offset angle θ. For example, where the number of cores is N is 8, the respective major axes of the elliptical cores can be offset from those illustrated in FIG. 1B by 45 degrees, such that the orientation of the uppermost core in FIG. 1B would be 45° and the successive cores would be oriented at 67.5°, 90°, 112.5°, 135°, 157.5°, 0°, and 22.5°. Thus, to account for the use of an offset angle in arranging the cores, the orientation φ of the major axis of a given elliptical core can be more broadly given by:

φ=(180/N)*n+θ.

where n is the core number, i.e. 1, 2, 3, 4 . . . , and θ is an offset angle including 0°.

It is further contemplated that variations in the direction of polarization of the input light will generate variations in the nature of the cylindrically polarized output light. For example, the respective directions of polarization of the input radiation in FIGS. 1A and 2A are offset by 90°and, as such, the output radiation in FIGS. 1C and 2C take two distinct forms of cylindrically polarized radiation, i.e., radially polarized in FIG. 1C and azimuthally polarized in FIG. 2C.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

What is claimed is:

1. A multicore optical component comprising a plurality of birefringent, polarization maintaining elliptical cores, wherein:
the elliptical cores are configured for optical propagation and extend from a common input end of the optical component to a common output end of the optical component;
the multicore optical component comprises N elliptical cores;
the elliptical cores collectively define an azimuthally varying distribution of major axes;
the orientation co of the major axis of a given elliptical core is given by
φ=(180/N)*n+θ
where n is the core number and θ is an offset angle including 0°.

2. An optical component as claimed in claim 1 wherein the elliptical cores define respective optical path lengths sufficient for coherent superposition of an optical signal propagating from the input end of the optical component to the output end of the optical component;

3. An optical component as claimed in claim 1 wherein the elliptical cores define respective optical path lengths sufficient for the generation of azimuthally distributed polarization outputs from the elliptical cores at the output end of the optical component, the azimuthally distributed polarization outputs producing a cylindrically symmetric amplitude and polarization state.

4. An optical component as claimed in claim 1 wherein each elliptical core rotates polarization as would a half waveplate.

5. An optical component as claimed in claim 1 wherein the elliptical cores comprise single mode elliptical cores.

6. An optical component as claimed in claim 1 wherein the multicore optical component comprises an optical fiber bundle.

7. An optical component as claimed in claim 1 wherein the multicore optical component is drawn from a fiber perform comprising a plurality of core canes.

8. An optical component as claimed in claim 7 wherein the core canes of the fiber perform are characterized by a cladding/core ratio of between approximately 1.5 and approximately 3.

9. An optical component as claimed in claim 1 wherein the respective major axes of the elliptical cores are between approximately two and approximately three times the size of corresponding minor axes of the elliptical cores.

10. An optical component as claimed in claim 1 wherein the polarization maintaining elliptical cores are symmetrically arranged in a circular array.

11. A method of converting a linearly or circularly polarized Gaussian beam of light into a radially or azimuthally polarized beam of light with a multicore optical component, wherein:
the multicore optical component comprises a plurality of birefringent, polarization maintaining elliptical cores;
the elliptical cores are configured for optical propagation and extend from a common input end of the optical component to a common output end of the optical component;
the multicore optical component comprises N elliptical cores symmetrically arranged in a circular array;
the elliptical cores collectively define an azimuthally varying distribution of major axes;
the orientation φ of the major axis of a given elliptical core is given by
φ=(180/N)*n+θ
where n is the core number and θ is an offset angle including 0°; and
the method comprises directing a linearly or circularly polarized Gaussian beam of light through the multicore optical component, wherein the multiple optical paths of the respective elliptical cores of the multicore optical component are sufficiently long to ensure conversion of the linearly or circularly polarized Gaussian beam of light into a radially or azimuthally polarized beam of light.

12. A method as claimed in claim 11 wherein linearly polarized input radiation is converted to radially polarized output radiation.

13. A method as claimed in claim 11 wherein linearly polarized input radiation is converted to azimuthally polarized output radiation.

14. A method as claimed in claim 11 wherein arbitrarily polarized input radiation is converted to radially or azimuthally polarized output radiation.

15. A method of converting an arbitrarily polarized input beam of light into a plurality of cylindrical vector beams of light comprising azimuthally varying polarizations with a multicore optical component, wherein:
the multicore optical component comprises a plurality of birefringent, polarization maintaining elliptical cores;
the elliptical cores are configured for optical propagation and extend from a common input end of the optical component to a common output end of the optical component;
the multicore optical component comprises N elliptical cores symmetrically arranged in a circular array;
the elliptical cores collectively define an azimuthally varying distribution of major axes;
the orientation φ of the major axis of a given elliptical core is given by
φ=(180/N)*n+θ
where n is the core number and θ is an offset angle including 0°; and
the method comprises directing the input beam of light through the multicore optical component, wherein the multiple optical paths of the respective elliptical cores of the multicore optical component are sufficiently long to ensure conversion of the input beam of light into the plurality of cylindrical vector beams of light comprising azimuthally varying polarizations.
